(19) United States
(12) Patent Application Publication
(10) Pub. No.: US 2008/0005285 A1
(43) Pub. Date: Jan. 3, 2008

(54) Method and System for Self-Scaling Generic Policy Tracking

(75) Inventors: James David Robinson, Lakeland, FL (US); Victor Maximillian Garcia, Lakeland, FL (US)

Correspondence Address: AKERMAN SENTERFITT, P.O. BOX 3188, WEST PALM BEACH, FL, 33402-3188, US

(73) Assignee: Impulse Point, LLC, Lakeland, FL (US)

(21) Appl. No.: 11/428,485

(22) Filed: Jul. 3, 2006

(51) Int. Cl. G06F 15/177

(52) U.S. Cl. 709/220

(57) ABSTRACT

A system (100) and method (600) is provided for self-scaling generic policy tracking. The system can include a policy key (210) on a client (132) for scanning the client for at least one configuration, assessing a policy compliance based on the configuration, and reporting at least one policy state to a policy server. The system can also include a policy server (110) for receiving the at least one policy state from the policy key, and configuring network access to the client based on the at least one policy state. The policy key can report at least one policy state (232) on a periodic communication cycle that can be scaled according to system load for increasing system capacity.

### FIELD OF THE INVENTION

The present invention relates to computer network systems and, more particularly, to network admission control.

### BACKGROUND

Network Admission Control (NAC) is a set of technologies and solutions that uses a network infrastructure to enforce security policy compliance on devices seeking to access network computing resources. NAC solutions attempt to ensure that critical security policies are enforced before a computer connects to a protected network, thereby limiting damage from potential and emerging security threats. NAC solutions generally allow only compliant and trusted endpoint devices to connect to other devices within the network. They can restrict a network access of noncompliant devices which can include computers, servers, and communication devices. One overarching goal of NAC solutions is to prevent computers with individual susceptibilities from threatening the entire network.

However, one of the problems with NAC is a limitation in the number of end user devices that can be managed. Currently, most implementations have an upper limit of around a few thousand concurrent users. Moreover, a network can include multiple devices from various manufacturers which may or may not be configured to operate with one another. Consequently, configuring network access to the devices often incurs significant management overhead. Accordingly, the configuration and management of the local computer systems is generally customized to provide interoperability and control between the multiple devices. A need therefore exists for increasing the number of users that can be managed concurrently and providing a managed configuration that simplifies interoperability for network administration control.

### OVERVIEW OF CERTAIN EMBODIMENTS

The embodiments herein presented are provided only for purposes of illustration and as an introduction to the detailed disclosure of the present application. They are not to be considered as limiting the scope of the invention in any manner.

One embodiment of the invention is directed to a system for self-scaling generic policy tracking. The system can include a policy key on a client for scanning the client for at least one configuration, assessing a policy compliance based on the configuration, and reporting at least one policy state to a policy server. The system can also include a policy server for receiving the at least one policy state from the policy key, and configuring network access to the client based on the at least one policy state. The configuring a network access can include opening or closing network access to the client.

The policy key can evaluate policy at the client and report a policy state to the policy server for providing self-scaling policy tracking. The policy state can asses the policy at the client and report a state of the policy to the policy server. Moreover, the policy key periodically reports to the policy server on a periodic communication cycle, which may take into account system load. As part of the periodic communication cycle, the policy key can supply policy states, receive commands, updates and directives from the policy server to perform actions such as changing the policy. As part of the periodic communication cycle, the policy key can also receive a command to present a web page, or receive a command to change the periodic communication cycle. In one example, the reporting cycle can be adjusted based on a number of active clients. The policy key can reside on a client for assessing policy, thereby relieving the policy server of policy evaluation and furthermore providing generic policy tracking. The policy server can enforce policy by configuring network access to the client in view of one or more policy compliances reported by the policy key. Moreover, the policy server can re-direct the client to one or more remediation services for complying with policy.

Another embodiment of the invention is directed to a method for self-scaling generic policy tracking. In one arrangement, the policy server can request the policy key to perform a Layer 2 blocking at the client if at least one policy state is not compliant. If the policy key cannot perform the Layer 2 blocking, the policy key responds to the policy server, and the policy server can perform a Layer 3 blocking. As one example, the Layer 3 blocking can prevent the client from communicating outside the network. As another example, the Layer 2 blocking can further isolate the client and prevent others within the network from communicating with the client.

Another embodiment of the invention is directed to a network access control method for performing Layer 2 blocking. The method can include preventing at least one client from communicating to nodes on a subnet of the at least one client by poisoning an access table to route back all communication attempts to the at least one client, preventing the at least one client from communicating to nodes outside the subnet by removing a default gateway and at least one route from a route table, allowing communication to a remediation service by entering a route in a route table that corresponds to a predetermined remediation server, and redirecting Domain Name Server (DNS) requests to remediation services by changing a DNS of the at least one client to a remediation server.

Yet another embodiment of the invention is directed to a network access control system that incorporates the self-scaling generic policy tracking methods in addition to Layer 2 blocking. The system can include a policy key on at least one client for scanning the at least one client for at least one configuration assessing at least one policy compliance based on the configuration, and reporting a policy profile that identifies a policy state of the at least one policy compliance to a policy server. The system can include a policy server for receiving the policy profile from the policy key regarding the policy state of the at least one policy compliance of the at least one client, evaluating at least one policy applying to the at least one client, determining whether network access should be granted to the at least one client based on the policy state in view of the at least one policy, and configuring network access to at least one endpoint solution of the at least one client if at least one policy state is not compliant.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a self-scaling generic policy tracking system in accordance with the embodiments of the invention;

FIG. 2 is a client and server arrangement for the self-scaling generic policy tracking system in accordance with the embodiments of the invention;

FIG. 3 is a description for a policy key in accordance with the embodiments of the invention;

FIG. 4 is a description for a policy server in accordance with the embodiments of the invention;

FIG. 5 is a workflow for Layer 3 blocking in accordance with the embodiments of the invention;

FIG. 6 is a workflow for self-scaling generic policy tracking in accordance with the embodiments of the invention;

FIG. 7 is a workflow for Layer 2 blocking in accordance with the embodiments of the invention;

FIG. 8 is an access table in accordance with the embodiments of the invention;

FIG. 9 is a route table in accordance with the embodiments of the invention;

FIG. 10 is a method for degraded blocking in accordance with the embodiments of the invention; and

FIG. 11 is a load balancing architecture in accordance with the embodiments of the invention.

### VARIOUS ENVIRONMENT

In embodiments of the invention, various functionality described herein may be performed by software executed by a computer or like device (e.g., a personal computer which attempts to access qualifying data, a personal computer which stores qualifying data). Such software may include application software, utility software, device drivers.

In other embodiments, such software may reside on another computer (e.g., a server). When executed, the software performs various functionality on one or more connected computers (e.g., personal computers which rely on the server for various resources).

In other embodiments, various functionality described herein may be performed by software executed by other devices such as cellular telephones, audio players, MP3 players (e.g., a cellular telephone which attempts to access qualifying data, an MP3 player which stores qualifying data).

In other embodiments, various functionality described herein may be performed by firmware or embedded hardware, such as a ROM storing certain instructions.

In other embodiments, various functionality described herein may be performed by peripheral device in communication with the device that is, e.g., attempting to access qualifying data, storing qualifying data.

In other embodiments, various functionality described herein may be performed by media readers or media writers, such as CD-ROM drive, a CD-RW drive, a DVD-ROM drive, a DVD-RW drive in communication with the device that is, e.g., attempting to access qualifying data, storing qualifying data. The drivers of such media readers/writers may perform some or all of the functionality.

The above embodiments are not mutually exclusive, since the functionality may be performed by a variety of apparatus in a variety of manners.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “processor” can be defined as any number of suitable processors, controllers, units, or the like that carry out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

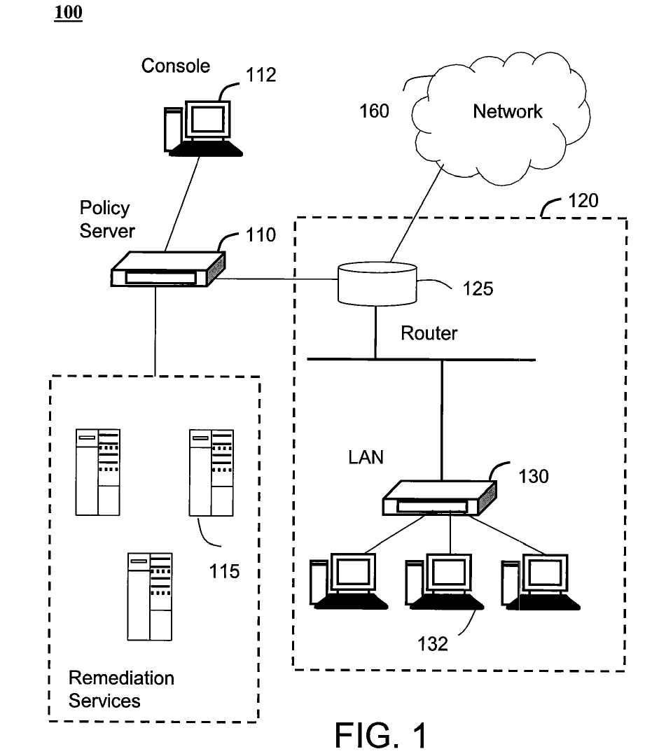

Referring to FIG. 1, a self-scaling generic policy tracking system 100 is shown. The system 100 can include a policy server 110 for managing at least one network 120. The policy server 110 can be cooperatively connected to a console 112 for allowing administrative access. In practice, the policy server 110 can manage a plurality of networks or individual devices though only one network 120 is shown. The network 120 can include a Layer 3 device, such as a router 125, that can be communicatively coupled to the policy server 110, the outside network 160, and the local area network (LAN) 130. Notably, configurations are not limited to those shown in FIG. 1, and the system can have more or less than the number of network configurations and components shown. In general, the LAN 130 can provide data connectivity to one or more clients 132, wherein a client 132 can be a computer, a phone, or a mobile communication device, such as a “BlackBerry”, a “PalmPilot”, though is not limited to these. As one example, the client 132 can connect to the Internet through the router 125 and to the outside network 160. The router 125 and the LAN 130 may also include firewalls for ensuring network security. The router 125 may also be replaced by a hub, a switch, a port-switch, or any other suitable Layer 3 device, and is not limited to being the router 125. Briefly, the policy server 110 can prevent the client 132 from accessing other clients on the LAN 130, and/or prevent the client 132 from communicating with other devices on the network 160. Understandably, infected systems and malicious users can impose a threat that warrants network managed security. Accordingly, the self-scaling generic policy tracking system 100 ensures that end point devices within the network 120 meet acceptable use policies. In addition, the policy server 110 can ensure that users of the devices connecting to the network have valid credentials for accessing the network resources.

The self-scaling generic policy tracking system 100 enables organizations to define, enforce and maintain acceptable use policies before granting network access. In one embodiment, the system 100 can prevent unauthorized access to wired, wireless and VPN networks. The system 100 can also ensure end points, such as the client 132, are compliant and, as an example, have up to date antivirus, antispyware and security patches. Non-compliant users can be isolated until acceptable use policies are met. Moreover, the system 100 provides effective and direct communication to a user regarding their assessment profile and the steps needed to comply with acceptable use policies for gaining network access; that is, the user can be informed of their compliance.

For example, a non-compliant client can be directed to one or more remediation services running on one or more remediation servers 115. In one arrangement, the remediation server 115 can present a webpage to a non-compliant user for informing the user as to what software needs to be downloaded or installed to be compliant with one or more policies applied to the user. The remediation server 115 can also present window based pop-up blocks, email messages, or send faxes to the non-compliant user. For example, a user of a mobile device attempting to log in to the network 120 may receive an email message on the mobile device regarding remediation actions for connecting to the network 120. The user can perform the remediation actions through the mobile device, wherein the remediation servers conveys instructions to a remote device or system, such as the router 125 or LAN 130.

In particular, the policy server 110 provides network admission control (NAC), which is essentially two components combined into one. First, NAC is the ability to restrict a computer's access to a network if the computer configuration does not meet policy. Second, NAC is the ability to restrict the individual user's access to a network based on policy. Notably, a distinction is made between providing the computer with network access and providing the user with network access. NAC solutions provide various means for restricting a computer's access to a network if the computer's configuration does not meet policy, and restricting an individual user's access to a network based on policy. As one example, NAC solutions can include authenticating a user prior to allowing the user access to the network. This can include restricting access at Layer 2 and/or Layer 3 based on an identity of the client. In general, Layer 2 corresponds to the data-link layer which provides synchronization for the physical level and furnishes transmission protocol knowledge and management. In general, Layer 3 corresponds to the network layer which handles the routing and forwarding of data.

In one aspect, the self-scaling generic policy tracking system 100 can restrict a computer's access to a network if a computer configuration does not meet policy. As previously noted, a policy can require that an anti-virus or anti-spyware program be installed and/or running. Furthermore, a policy can require that the program is up to date, such as by date of installation or version number. Notably, as an example, the policy key detects for a presence of the antivirus program and not the virus; that is, the policy key does not attempt to detect the virus, only whether the software for detecting the virus is present. Accordingly, the policy server 110 can check the client 132 for anti-virus programs, anti-spyware programs, installed security patches, and peer-to-peer programs. This allows the system 100 to focus on various areas of security information management which can include vulnerability discovery, security event management, and network communication. For example, the policy server 110 can also monitor and detect newly emerging threats, quarantine problem computers, and automatically remediate security events. Moreover, the policy server 110 can provide posture assessment, which is the evaluation of system security based on the applications and settings that a local machine is using. The endpoint security and policy compliance are designed to inspect, assess, ensure compliance to policy, and remediate at the network endpoint source, prior to network access. Such solutions can deliver endpoint security by enabling only trusted and privileged devices onto the network.

As is known in the art, most systems have bottlenecks in their architecture which limit the number of users that can be actively monitored for compliance, which may approach 1500 active users. Embodiments of the invention herein presented employ a two-fold methodology that provides scaling up to a higher number, such as 20,000, but is not limited to this number, which may be more or less than this amount. The two-fold methodology includes a server component and a client component. Moreover the two-fold method provides for management of generic network components.

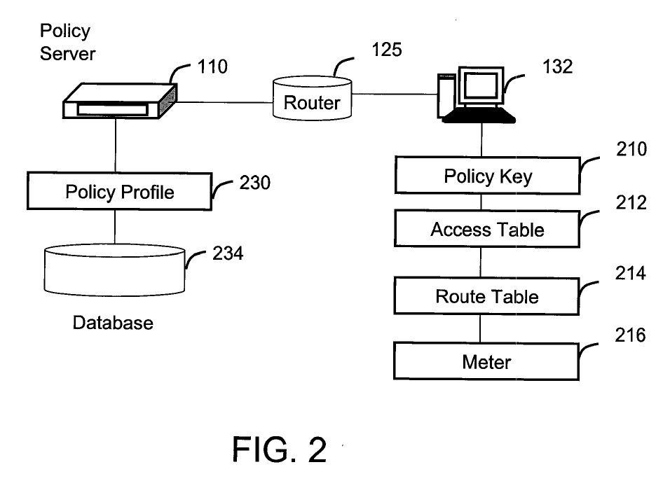

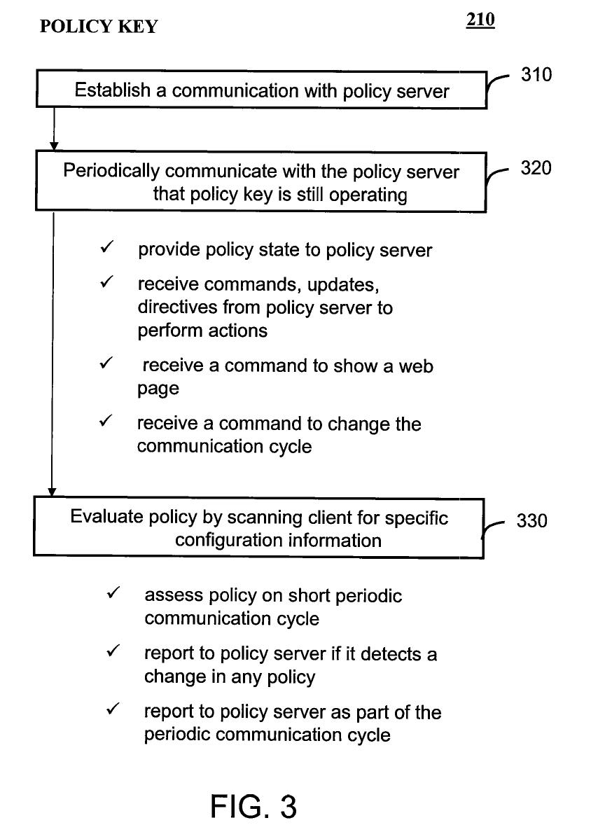

Referring to FIG. 2, a client and server arrangement 200 for self-scaling generic policy tracking is shown. Notably, the client and server arrangement 200 can be implemented using a combination of a server side component (policy server 110) that controls access, and a client component (client 132) that reports a profile for compliance with policy. The policy server 110 can maintain a policy profile 230 (also see FIG. 3) that reveals a compliance of the client 132 to one or more policies. The policy server 110 can also have access to a database 234 for storing one or more policy profiles 230. Briefly, the client 132 can include a policy key 210 for assessing and reporting one or more policy compliances. The policy key 210 can also configure the client's 132 network access. Accordingly, the policy key 210 can control an access table 212 for altering one or more communication routes of the client 132 within the network 120 (See FIG. 1). Similarly, the policy key 210 can also control a route table 214 for preventing the client 132 from communicating with other clients. The policy key 210 can also include a meter 216 for cycling multiple clients in and out of the access table 212 during overload conditions.

Briefly referring to FIG. 3, one or more responsibilities of the policy key 210 are shown. For example, at 310, the policy key 210 can establish communication with the policy server 110. In one arrangement, the policy key 210 can communicate with the policy server 110 over an Hypertext Transfer Protocol (HTTP) connection, which may also be a secure connection, HTTPS, but is not limited to these. For example, the policy key can communicate over connectionless services or wireless protocol connections. As one example, the policy server can employ a webserver such as a Tomcat, Apache, or Java architecture to receive and process policy related communications. The policy key 210 can be installed on an individual node, which can be an endpoint device such as the client 132, and which may be as a computer, a mobile communication device, or any other suitable communication device connected to the network 120. In practice, the policy key 210 assesses and reports a policy state of one or more policies applied to the client 132. The policy key 210 sends one or more policy states to the policy server 110 depending on the number of policies applied to the client 132. The policy state reveals whether the client is compliant with at least one policy that has been applied to the client.

As an example, within the network 120 (See FIG. 1), an administrator may require that clients within the network comply with certain policies, such as having a anti-virus program installed. Understandably, the policy is not limited to anti-virus programs and can include any processes or features executing or present on a device. For example, a policy can identify multimedia processes running on the device and a status, usage, or resource capacity of the associated process.

In one arrangement, the policy key 210 can report to the policy server 110 on a periodic communication cycle. Briefly referring to FIG. 3, at 320, the policy key 210 can periodically communicate with the policy server 110 that the policy key 210 is still operating; that is it have a “heartbeat”. As part of the policy key's periodic communication cycle, the policy key can supply the state of all policies to the policy server 110, or receive commands, updates, and directives from the policy server 110 to perform actions such as changing or updating the policies or policy communication cycles. Moreover, the policy key 210 may receive a command to show a web page. For example, the policy key 210 can present a web page to the client 132 for informing the client that the client is not policy complaint. Accordingly, the webpage may present at least one component that needs to be installed for achieving policy compliance and/or restoring network access as part of a remediation service.

Briefly referring to FIG. 3, at 330, the policy key 210 can evaluate policy by scanning the client for specific configuration information. In practice, the policy key 210 executes on the client 132 and scans the client 132 for at least one configuration. For example, the policy key 210 can be a software program, a plug-in component, or an application executing on the client 132, though is not herein limited to these. The policy key 210 assesses at least one policy compliance based on the configuration, and reports a policy state to the policy server 110. That is, the policy key 110 can evaluate one or more configurations of the client 132 for determining whether the client 132 complies with the one or more policies. For example, a policy may have been previously applied to the client 132 which required the client 132 to have an installed anti-virus program. The policy key can scan the client for at least one file, at least one executing process, or at least one registry key and registry key value to determine whether the anti-virus program is installed, but is not herein limited to these. Such examples correspond to scanning the client 132 for a configuration.

A configuration of the client 132 can determine whether the antivirus program is installed. For example, a configuration may be a known directory path where the antivirus program is generally installed. A configuration may be a location of where the process is executing. Accordingly, the policy key 210 can search for the path of the program to determine if the program is installed and a date of the installation. The policy key 210 can also identify a version number of the program during the scanning for ensuring an up-to-date compliance. Upon completion of the scanning, the policy key 210 can report a policy state based on the configuration. For example, the policy key 210 can assign a policy state of “pass” or “fail” for addressing policy compliance. Similarly, the policy state can assign a “true” or “false” for addressing policy compliance.

One or more policy states can be maintained in the policy profile 230 and which can be enforced by the policy server 110. Briefly, the policy server 110 can receive one or more policy states from the policy key 210 and store the policy states to the policy profile 230. The policy server 110 can configure network access to the client and enforce the one or more policies based on the policy profile. As an example, the policy server 110 can open or close network access in view of the policy state. Notably, the policy server can configure network access for preventing unauthorized access to wired, wireless, and virtual private networks, though is not limited to only blocking these networks.

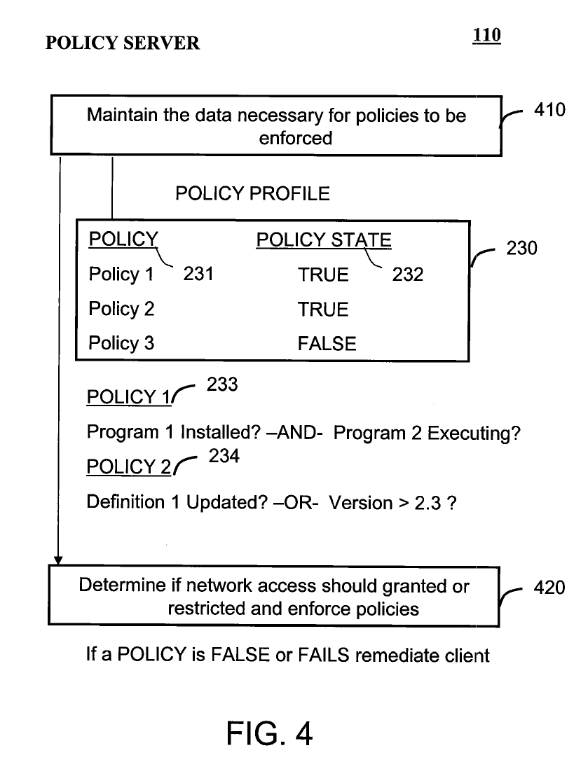

Briefly referring to FIG. 4, one or more responsibilities of the policy server 110 are shown. At 410, the policy server 110 can maintain data necessary for policies to be enforced. For instance, a policy profile 230 is shown. The policy profile 230 can identify one or more policies 231 and corresponding policy states 232. In another arrangement, the policy profile 230 can identify a component by name and a corresponding policy state that describes whether the component is installed, absent, corrupt, failed, or accepted. It should be noted that a client is policy compliant if the configuration of the client matches a policy applied to the client. For example, Policy 2 can identify a policy compliance for an antivirus program and the corresponding policy state “True” reveals that the client 132 is compliant with the policy; that is, the client 132 has the antivirus program installed. In another arrangement, the entries in the policy profile 230 can be presented as a simple statement such as “Antivirus-Installed—PASS”, or “Authentication—FAIL”, and the like.

A policy can be a set of instructions specifying a configuration of the client. As one example, the policy 233 can be a Boolean logic command inquiring as whether a certain program are installed, or not installed. Furthermore, the policy 233 may include simple logic operators such as greater than or less than for identifying various policy requests. As another example, the policy 234 can ask whether a version number is greater or less than a predetermined version. The policy server 110 can also prioritize the policy states 232 in the policy profile 230 and respond to the client in order of priority. For example, one policy 231 may require a certain procedure for blocking network access, whereas another policy 231 may require a different procedure for blocking network access. As one example, the computational complexities associated with the blocking network access can establish the priority.

It should also be noted, that the policy server 110 may not know the component, or program, associated with the policy 231. That is, the policy server 110 maintains decision logic for enforcing policy, though does not evaluate policy. Accordingly, the policy server 110 may not be aware of the policy being enforced. Understandably, this provides a layer of abstraction wherein the policy server is insulated from proprietary information. In this aspect, the policy server 110 does not determine which policies apply to the client, it only determines whether the client is compliant or non-compliant with the policies. For instance, referring to FIG. 3, the policy server 110 may receive a policy state 232 for three policies 231. Understandably, the policy client 210 has reported three policy states to the policy server 110 that apply to the client. In this example, the decision logic evaluates a true or false state and configures the network access in accordance with all three reported policy states 232. The policy server 110 may not inquire as to which policies to enforce, given that the policy evaluation is determined by the policy key 210.

At 420 (See FIG. 4), the policy server 110 can determine if network access should be granted or restricted based on the policy profile 230. The policy server 110 can enforce policy if the client 132 is not compliant with one or more policies 231. For example, the policy server 110 can determine whether a policy is “false” or “fails” and remediate the client accordingly. As noted above, the policy server 110 is responsible for enforcing policy compliance, and not evaluating policy. That is, the policy server 110 does not scan the client 132 to determine whether a configuration is policy compliant, or consider the policies in view of the policy state. It is the policy key 210 that is generally responsible for the evaluation and assessment of policies applied to the client. Policy evaluation is delegated to the policy key 210 in order to off-load the processing work to the client 132 and relieve the workload on the policy server 110. Consequently, the policy key 210 is responsible for initiating communication with the policy server 140 regarding policy compliance. That is, the policy server 110 does not establish communication with the policy key 210. It is the policy key 210 that initiates communication to the policy server 110.

One embodiment of the invention provides a self-scaling aspect to policy tracking. For example, the policy server 110 can determine a total number of clients sending policy profiles, determine a support rate for the policy profiles that can be handled by the policy server 110, and determine a contact period based on a variable algorithm that uses the total number of active clients and the support rate. The policy key 210 can be informed of the contact period by the policy server 110 on a next policy communication cycle. For example, the policy server 110 can adjust a policy reporting interval for the policy profiles based on total system load. That is, the policy server 110 can scale out policy reporting intervals from the policy key 210 to increase a scaleability of the system, and thereby increase policy tracking capacity. As one example, the variable algorithm can determine the total number of active clients (policy keys) in the system, and divide the total number by the amount of policy key based HTTP calls that the policy server 110 can process per second. For example, in a system that has 6000 active policy keys where the policy server 110 can handle 5 calls per second, a policy key 210 that reports to the policy server 110 on a policy communication cycle will be told not to contact it again for 1200 seconds (20 minutes). Notably, the policy key 210 initiates communication with the policy server 110. The policy server 110 does not contact the policy key 110, unless the policy key initiates the communication. Accordingly, the policy server can react faster to overload conditions by scaling out the reporting intervals based on system load. For example, after a power surge, when many computers are rebooted, multiple users may log on simultaneously causing overload conditions. Accordingly, the policy server 110 can scale out policy profile reports for addressing system capacity issues.

Notably, the policy key 210 and the policy server 110 work in unison. Moreover, the policy key 210 generally reports to the policy server 110 only if the policy key 210 detects a change in policy, as part of the policy communication cycle, or at system start-up. Furthermore, the policy key 210 acquires all the all information necessary to evaluate individual policies at the client 132 without reliance on the policy server 110. For example, the policy client 210 scans the client 132 for a configuration without oversight from the policy server 110. Accordingly, the policy client 210 performs the processing independently of the policy server 110 and contacts the policy server 110 only when necessary. Consequently, the policy server 110 can scale out policy profiles (i.e. heartbeats) by delegating policy evaluation to multiple policy keys thereby increasing the number of clients that can be managed. That is, the policy client 210 is self-sufficient, and this provides system scalability.

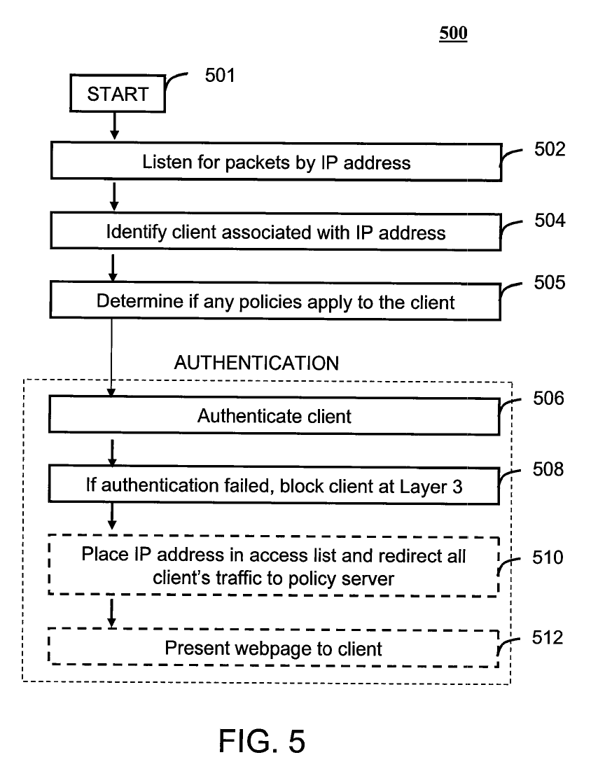

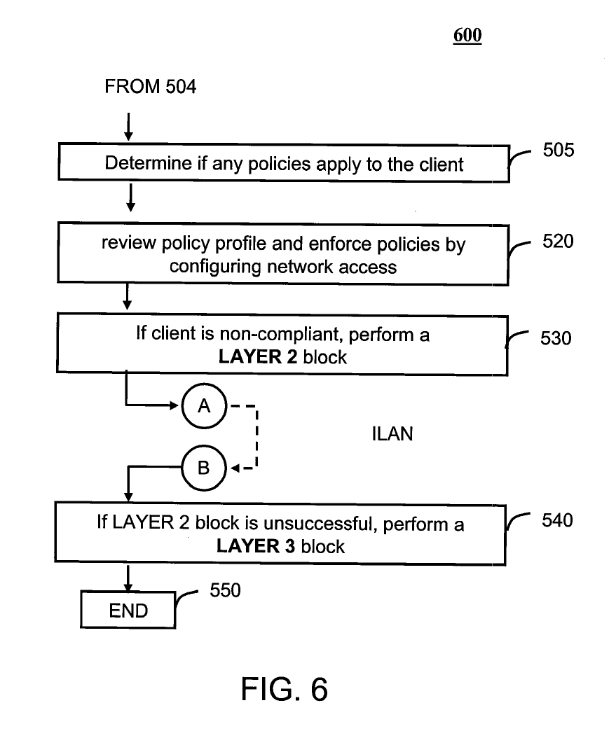

Referring to FIG. 5, a workflow 500 for blocking an unauthorized client is shown. Briefly, the workflow 500 performs a Layer 3 block if an unauthorized client attempts to connect to the network. A broader workflow will be presented ahead in FIG. 6. The workflow 500 can be practiced with more or less that than the number of steps shown. To describe the workflow 500, reference will be made to FIG. 2 although it is understood that the workflow 500 can be implemented in any other suitable device or system using other suitable components. Moreover, the workflow 500 is not limited to the order in which the steps are listed in the workflow 500. In addition, the workflow 500 can contain a greater or a fewer number of steps than those shown in FIG. 5.

At step 502, the policy server 110 (See FIG. 2) can listen to network activity at one or more IP addresses. For instance, the router 125 can report bandwidth usage to the policy server 110 concerning one or more IP addresses active on the LAN 130. At step 504, the policy server 110 can associate an IP address with a client. At step 505, the policy server 110 can determine if any policies apply to the client. Also, the policy server 110 can determine if any new policies apply to the client. For example, the user may be new to the network and may need to login. At step 506, the policy server 110 can authenticate the client. For example, the policy server 110 can present a login screen, as an example, for the user to enter in a name and password. At step 508, if the authentication fails, the client can be blocked at Layer 3. This can prevent the client from connecting to the network of the Internet. For example, referring to FIG. 2, the Layer 3 blocking can occur at the router 125. At step 510, the IP address can be placed in an access list for redirecting the client's traffic to the policy server. At step 512, the policy server 110 can present a webpage to the client to inform the client of the policy state. Understandably, the policy server 110 may delegate this responsibility to one or more remediation servers 115 for offloading work at the policy server 110. FIG. 5, was presented as a methodology for Layer 3 blocking based on the policy server 110 and policy key 210 relationship. Understandably, the policy key 210 provides policy states to the policy server 110, for allowing the policy server 110 to determine what policies should be enforced and how to configure the network access to the client accordingly.

Embodiments of the invention are also directed to enforcing one or more policies by blocking network access at Layer 2 in addition to Layer 3. For example, the policy server 110 can restrict a computer, such as client 132 from accessing network resources at the client, if the client is not compliant with one or more policies. This is in contrast to blocking the client at a Layer 3 device, such as the router 125. As one example, briefly referring to FIG. 2, the policy server 110 can perform Layer 3 blocking at the router 125 in accordance with one or more policies to prevent the client 132 from communicating with clients outside the network 120. Understandably, the policy server 1110 can block other types of Layer 3 devices, such as switches, hubs, switches, and port-switches which may be present in place of, or concurrent with, the router 125.

Alternatively, software components, such as the policy key 210, installed on the client 132 can perform Layer 2 blocking in order to prevent the client 132 from communicating with other devices. In this manner, the self-scaling generic policy tracking system 100 can, as a first attempt, perform a specific block at Layer 2 to completely isolate the client 132 not only from the outside network, but also clients within the network. And, if the block at Layer 2 is unsuccessful, the system 100 can perform a higher layer block at level 3 for preventing the client 132 to communicate with other nodes or end-points outside the network.

Referring to FIG. 6, a workflow 600 for policy tracking is shown. The workflow 600 can extend from the workflow 500 presented in FIG. 5, though is not limited to following only from workflow 500. In particular, the workflow 600 reveals when Layer 3 blocking actions are enforced, and when Layer 2 network blocking actions are enforced. To describe the workflow 600, reference will be made to FIGS. 2 and 3 although it is understood that the workflow 600 can be implemented in any other suitable device or system using other suitable components. Moreover, the workflow 600 is not limited to the order in which the steps are listed in the workflow 600. In addition, the workflow 600 can contain a greater or a fewer number of steps than those shown in FIG. 6.

For example, referring to FIG. 2, the workflow 600 can branch from a state 504 wherein the policy server 110 (See FIG. 2) is listening for a network activity at one or more IP addresses. The policy server 110 can associate the IP address with the client 132, and enforce a policy of the client 132 in view of the policy profile 230 (See FIG. 4). At step 505, the policy server 110 can check the client for applied policies (This correlates to step 505 in FIG. 5). For example, the policy server 110 can determine if one or more policies have been applied to the client 132. Alternatively, the policy server 110 can intercept an IP address and evaluate whether any policies have been applied to the client 132 associated with the IP address.

At step 520, the policy server can review the policy profile 230. For example, referring to FIG. 4, the policy server 110 can review the policy profile 230 and determine if the client is compliant with one or more assigned policies. If the client 132 is compliant, the policy server 110 can proceed to check another client for policy compliance. Notably, the self-scaling aspect of the invention allows the policy server to manage policy tracking of numerous clients. However, if the client 132 does not comply with one or more policies, the policy server 110 can enforce the policies by configuring network access to the client 132.

This can include a Layer 2 blocking attempt followed by a Layer 3 blocking attempt. For example, upon determining that the client 132 does not comply with one or more policies (See FIG. 3), at step 530, the policy server 110 can send a request to the policy key 210 to perform a Layer 2 blocking at the client 132. A Layer 2 block is a more stringent block than a Layer 3 block which might occur at the router 125. The layer 2 block prevents the client 132 from communicating to nodes on a subnet of the client.

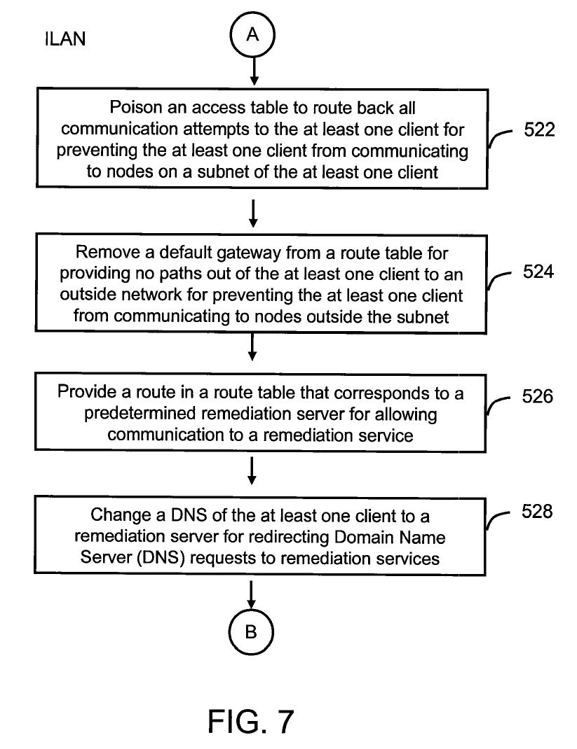

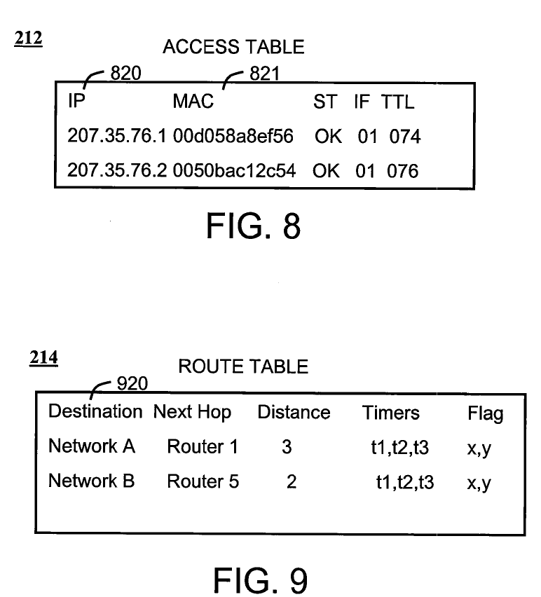

In the foregoing, reference will be made to FIG. 7, for presenting methods steps 522-528. The method steps 522-528 are referred to collectively as an Individual Local Area Network (ILAN) 500, and which provides Layer 2 blocking at the client. At step 522, the policy key 210 can perform the Layer 2 block by poisoning an access table 226 (See FIG. 4) to route back all communication attempts to the client. Briefly referring to FIG. 8, the access table 212 is shown in greater detail. The access table 212 can include an Internet Protocol (IP) address 820 and a Media Access Control (MAC) address 821, as well as other parameters (not enumerated, but shown). The access table 212 can be an Address Resolution Protocol (ARP) table as is known in the art. The ARP table can contain entries for the LAN 130. In practice, the policy key 210 (See FIG. 2) blocks network access to the client 132 by replacing dynamic IP addresses in the ARP table 212 with static IP addresses. In particular, the policy key removes an IP addresses of a dynamic type having an associated Media Access Control (MAC), and inserts that IP addresses with a static type and a MAC address of the client. This re-routes any communication queries back to the client 132 and prevents network access to other nodes on a subnet of the client. The step 410 for poisoning the access table can also include monitoring the Address Resolution Protocol (ARP) cache, waiting for an entry to be inserted in the ARP cache, and upon insertion, on a policy communication cycle, informing the policy key 210 to block the at least one client. The policy server waits until the next communication cycle, as the policy key is responsible for initiating communication with the policy server.

At step 524, the policy key 210 can perform another Layer 2 block by removing a default gateway from a route table 214 (See FIG. 2) for preventing the client from communicating to nodes outside the subnet. The route table 214 can be present on the client 132 as an abstraction of a route list on the router 125. Briefly referring to FIG. 9, a route table 214 is shown in greater detail. The route table 214 can include entries for a destination address 920, a next hop, a distance, timers, flags, and the like (not enumerated, but shown) as is known in the art, and is not limited to these. Moreover, the route table can include entries for a netmask, a default gateway entry, an interface, and one or more metrics. Notably, the route table 214 can correspond to routes for various Layer 3 devices, such as hubs, switches, and ports. That is, embodiments of the invention are not restricted to a route table 214 solely for the router 125. In practice, the policy key 210 removes a default gateway from the route table for providing no path out of the client to a network available to the client. For example, a destination 920 entry corresponding to the default gateway can be removed. This prevents the client from communicating to other nodes outside the subnet.

At this point, as a result of steps 522 and 524, the client is effectively stopped from communication via Layer 2 blocking, though, the client is not completely blocked. In order to provide remediation services to the client, at least two more steps may be performed by the policy key on the client. These steps will effectively point the client to the policy server, or a remediation server, and allow the client to receive communication from the remediation server.

At step 526, the policy key 210 can allow communication to a remediation or messaging service. For example, the policy key 210 can change a DNS of the at least one client to a remediation server for redirecting Domain Name Server (DNS) requests to remediation services. In practice, the policy key 210 can enter an IP address and any corresponding information in the route table 214 to route traffic to a predetermined remediation server 115 (See FIGS. 1 and 2). For example, this can include entering in an IP address with an associated physical address (MAC), and designating a type of the IP address as dynamic or static. In effect, this re-directs the client 132 to the policy server 110 which may also be a remediation server 115. At this point, the client has been redirected to a remediation server, though the client may not be able to receive data. For example, the client 132 will not be able to see a webpage presented by the remediation server. That is, if the client attempts to access a web page, no page will be presented.

Accordingly, at step 528, the policy key 210 can change a Domain Name Service (DNS) to redirect the client to the remediation server for providing internet access. In particular, this allows the client to see a webpage. This can include changing a registry setting on the client 132. Consequently, the client 132 which has been redirected to remediation server 115 by step 526, can now receive one or more webpages from the remediation server 115 because the DNS has been set to the remediation server 115. As one example, the remediation service provided by the remediation server 115 can present a compliance web page to the client 132 for informing the client of at least one policy that needs to be installed or adhered to. The remediation service allows the client to achieve compliance and network access. In another aspect, the remediation service can be a messaging service that sends an email message, a text message, a fax, or any other suitable messaging format to the client 132. For example, an email can be sent to the client 132 that provides a link to a webpage for downloading or installing policy compliant software. The link can correspond to a website for downloading anti-virus software programs, definitions, or patches.

In practice, a client 132 that does not comply with policies will be quarantined until the client 132 has completed remediation services. For example, referring to FIG. 1, the client 132 will be unable to communicate with any nodes within the network 120 and the outside network 160. Because the client is under quarantine, the client 132 can communicate only with the policy server 132 and the remediation servers 115. As an example, the client 132 may be remediated after downloading and installing updated virus definitions presented by the remediation services. In certain cases, the remediation server 115 allows access to certain subnets while restricting access to others For example, this allows the client to browse the internet through a network without allowing them to contact any other node within the network.

Following step 528 (return to FIG. 6), the policy key 210 can inform the policy server 110 whether a Layer 2 block was successful. If the Layer 2 block, which may encompass one or more of the method steps 522-528, is successful, the policy server 110 may be satisfied with the network access configuration. A successful Layer 2 block isolates the client 132 at the node level. That is, the client 132 cannot communicate with peers within the network 120 or outside the network 120. Accordingly, the client 132 is quarantined and secure. If however, the policy key 210 is unable to perform a Layer 2 block, the policy server 110, at step 540, can perform a layer 3 block. For example, the policy server 110 can block network access at a layer 3 device such as the router 125 as was shown in FIG. 5 during authentication. Accordingly, the client 132 is prevented from communication with other clients outside the network 120.

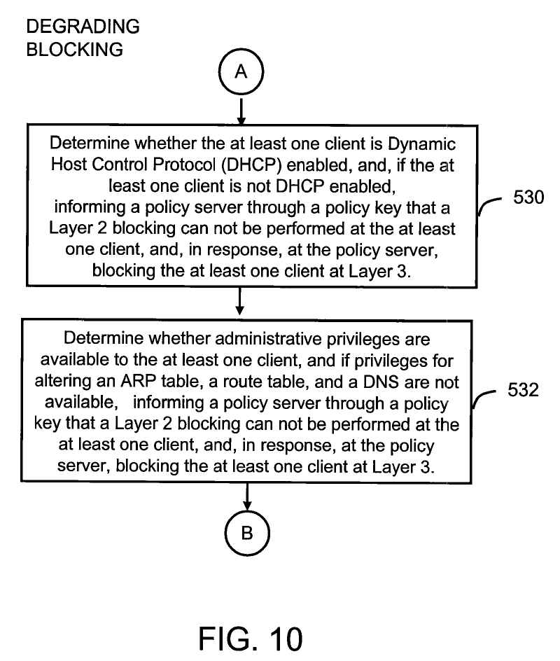

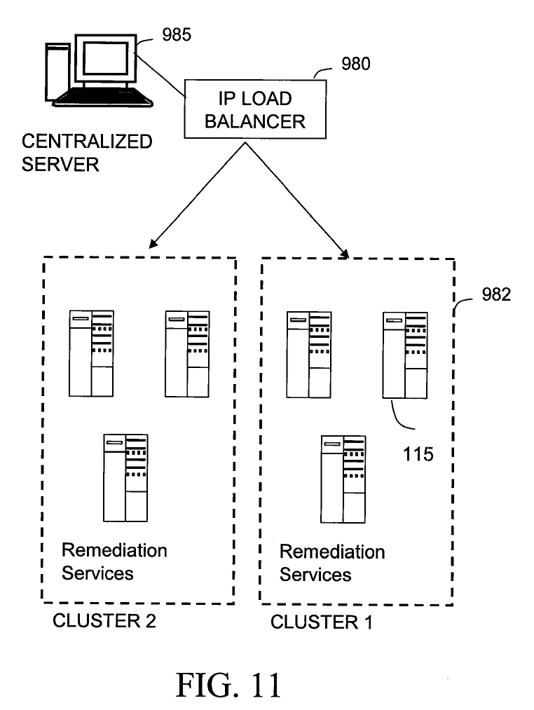

It should be noted that a Layer 2 block using method steps 522-528 may not be successful if the client 132 does not have DCHP enabled, or the client 132 does not have certain privileges. Accordingly, the method 600 can include method steps 530 and 532 shown in FIG. 10. The method steps 530 and 532 are degrading blocking methods. In particular, method step 530 can determine whether the client is Dynamic Host Control Protocol (DHCP) enabled. If the client is not DHCP enabled, the policy key can inform the policy server that a Layer 2 blocking could not be performed at the client, and, in response, the policy server, can block the client at Layer 3. Similarly, method step 532 can determine whether privileges for altering an ARP table, a route table, and a DNS are available to the client. If the client does not have administrative privileges, the policy key can inform the policy server that a Layer 2 blocking could not be performed at the client, and, in response, the policy server, can block the client at Layer 3. At step 550, the workflow 600 can end.

Briefly referring back to FIG. 1, a first remediation server 115 can be support anti-virus protection, a second remediation server can support anti-spyware, and a third remediation server can support software patches. Understandably, the remediation servers can be distributed for increasing a scalability of the system. Moreover, the self-scaling generic policy tracking system 100 can provide load balancing and clustering. For example, referring to FIG. 11, the remediation services containing remediation servers 115 of FIG. 1 can be considered an application cluster 982, and a load balancer 980 can be employed to off-load the policy server and redirect policy enforcement to one or more application clusters. The load balancer can increase system scalability by distributing workload to multi-threaded servers.

For even larger systems the load balancing architecture of FIG. 11 provides for clustering techniques that are available to generic web server applications. For example, the database 234 (See FIG. 2) and web server 115 (See FIG. 1) for remediation can be split off to a separate, centralized server 985. This centralized server 985 can handle 2 to 3 times the capacity because it will not be processing the individual policy key communications. The centralized server 985 will handle only the resulting database operations and the occasional web page request for non-compliant users. The centralized server 985 can distribute multiple policy key processing servers 110 at different locations to process HTTP communications from the policy keys.

Moreover, the centralized server 985 architecture for self-scaling generic policy tracking allows for provisioning of remote network access and control. Accordingly, methods for managed Service can include controlling network access via a remotely hosted policy server residing in a data center at a client site. The policy server communicates with local network resources at the client site, such as routers, switches, hubs, port-switches, to control network access remotely. A remotely hosted arrangement allow for more extensive use of the client side software to enforce layer 2 blocking.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

1. A method for self-scaling generic policy tracking, comprising:
at a policy key on a client,
scanning the client for at least one configuration;
assessing a policy compliance based on the configuration; and
reporting at least one policy state to a policy server, and
at the policy server,
receiving the at least one policy state from the policy key; and
configuring network access to the client based on the at least one policy state, wherein the configuring a network access includes opening or closing network access to the client.

2. The method of claim 1, wherein the policy server requests the policy key to perform a Layer 2 blocking at the client if the client is not compliant with a policy.

3. The method of claim 2, wherein the Layer 2 blocking comprises:
preventing the client from communicating to other nodes on a subnet of the client by poisoning an access table to route back all communication attempts to the client;
preventing the client from communicating to other nodes outside the subnet by removing a default gateway and at least on route from a route table for providing no paths out of the client to a network available to the client;
opening communication to a remediation service by providing a route in the route table that corresponds to a predetermined remediation server; a redirecting Domain Name Server (DNS) requests to remediation services by changing a DNS of the at least one client to a remediation server.

4. The method of claim 2, wherein if the policy key cannot perform the Layer 2 blocking, the policy key responds to the policy server, and the policy server performs a Layer 3 blocking.

5. The method of claim 1, wherein the policy key reports the at least one policy state on a periodic communication cycle.

6. The method of claim 5, wherein the policy key initiates communication to the policy server, and if the policy server needs to provide information to the client, the policy server does so at a time corresponding to the periodic communication cycle of the policy key.

7. The method of claim 5, wherein the policy key receives at least one of a command, an update, or a directive from the policy server to perform an action at a time corresponding to the periodic communication cycle of the policy key.

8. The method of claim 7, wherein the action is a change of a policy for which the policy key is scanning on the client.

9. The method of claim 5, wherein the policy key receives a command to change the periodic communication cycle at a time corresponding to the periodic communication cycle of the policy key.

10. The method of claim 1, wherein the policy key has complete information for evaluating a policy on a client.

11. The method of claim 1, wherein the policy key sends the at least one policy state to the policy server if the policy key detects a change in policy, as part of a periodic communication cycle, or at system start-up.

12. The method of claim 1, wherein the policy key scans the client for at least one file, at least one executing process, or at least one registry key and registry key value.

13. The method of claim 12, wherein scanning the client includes:
determining whether the client has at least one of an antivirus program, am antispyware program, a security patch, or a peer-to-peer program that is on the client.

14. The method of claim 12, wherein scanning the client includes:
identifying a version number for the at least one program for ensuring an up-to-date compliance, and the policy state identifies whether the at least one program complies with the policy.

15. The method of claim 1, wherein the policy state is a Pass/Fail, and the policy key sends only a Pass or Fail result of the policy evaluation to the policy server.

16. The method of claim 1, wherein a policy is a set of instructions specifying a configuration of the client.

17. The method of claim 1, wherein the policy key communicates with the policy server over an HTTP connection.

18. The method of claim 1, further comprising presenting a web page to the client for informing the client of non-compliance.

19. The method of claim 1, further comprising:
determining a total number of clients sending policy states;
determining a support rate for the policy states that can be handled by the policy server;
determining a contact period based on a variable algorithm that uses the total number of active clients and the support rate; and
informing the policy key of the contact period on a periodic communication cycle.

20. The method of claim 5, wherein the policy server requests the policy key to delay the sending of the at least one policy state in response to at least one overload condition.

21. The method of claim 20, wherein the at least one overload condition is a result of multiple users accessing a network.

22. The method of claim 1, wherein the policy server includes a policy profile that reports a component that is scanned on the client and a corresponding policy state that describes whether the component is installed, absent, corrupt, failed, or accepted.

23. The method of claim 22, wherein the policy server maintains decision logic for enforcing the at least one policy, and the client is policy compliant if the configuration of the client matches the at least one policy.

24. The method of claim 22, wherein the policy server determines whether network access is granted based on the policy profile.

25. The method of claim 1, wherein the configuring a network access includes preventing unauthorized access to wired, wireless, and virtual private networks.

26. The method of claim 1, wherein the policy server prioritizes a plurality of policy states and responds to the client in order of priority.

27. The method of claim 3, wherein the Layer 2 blocking restricts an end point solution on the client from communicating with at least one node on a network of the client.

28. The method of claim 3, wherein the Layer 2 blocking prevents the endpoint solution on the client from discovering an endpoint solution on at least one node in a sub-network of the client.

29. A system for self-scaling generic policy tracking, comprising:
a policy key on a client, for
scanning the client for at least one configuration;
assessing a policy compliance based on the configuration; and
reporting at least one policy state to a policy server,
the policy server, for
receiving the at least one policy state from the policy key; and
configuring network access to the client based on the at least one policy state, wherein the configuring a network access includes opening or closing network access to the client.

30. The system of claim 29, wherein the policy server requests the policy key to perform a Layer 2 blocking at the client if at least one policy state is not compliant, and if the policy key cannot perform the Layer 2 blocking, the policy key responds to the policy server, and the policy server performs a Layer 3 blocking.

31. The system of claim 30, wherein the policy key performs the Layer 2 blocking by:
preventing the client from communicating to other nodes on a subnet of the client by poisoning an Address Resolution Protocol (ARP) table to route back all communication attempts to the client; and
preventing the client from communicating to other nodes outside the subnet by removing a default gateway and at least one route from a route table for providing no paths out of the client to a network available to the client;
opening communication to a remediation service by entering a route in the route table that corresponds to a predetermined remediation server; and
redirecting Domain Name Server (DNS) requests to remediation services by changing a DNS of the at least one client to a remediation server.

32. The system of claim 30, further comprising:
a Layer 3 device connected to the server and the client for managing network communications,
wherein the policy server blocks the client at the Layer 3 device if the policy key cannot perform the Layer 2 blocking.

33. The method of claim 32, wherein the policy server:
listens for network activity from the Layer 3 device at an IP address of the client;
evaluates a policy management for the client based on the IP address; and
performs a Layer 3 blocking of the client based on the IP address at the Layer 3 device.

34. The system of claim 32, wherein the Layer 3 device is a router, a switch, a hub, or a port-based switch.

35. The system of claim 32, wherein the client is a computer, a phone, or mobile communication device, an internet protocol based device, or any device that is communicatively connected to a network.

36. The system of claim 22, wherein the policy server enforces policy, and does not evaluate policy.

37. The system of claim 29, further comprising:
a load balancer for offloading the policy server and redirecting the at least one policy profile to one or more application clusters.

38. The system of claim 29, further comprising:
at least one application cluster for increasing a scalability of the system.

39. A method for network administration control, comprising:
preventing at least one client from communicating to nodes on a subnet of the at least one client by poisoning an Address Resolution Protocol (ARP) table to route back all communication attempts to the at least one client;
preventing the at least one client from communicating to nodes outside the subnet by removing a default gateway and at least one route from a route table for providing no paths out of the at least one client to an outside network;
allowing communication to a remediation service by providing a route in the route table that corresponds to a predetermined remediation server; and
redirecting Domain Name Server (DNS) requests to remediation services by changing a DNS of the at least one client to a remediation server.

40. The method of claim 39, wherein the poisoning an ARP table comprises:
removing an IP addresses of a dynamic type having an associated Media Access Control (MAC), and
inserting the IP addresses with a static type and a MAC address of the client.

41. The method of claim 39, wherein the removing a default gateway and all routes from the route table that allow the client to connect to machines on the subnet.

42. The method of claim 39, wherein the remediation service is a messaging service that presents a web page to the at least one client for informing the at least one client of at least one policy that needs to be installed for meeting compliance and restoring network access.

43. The method of claim 39, further comprising a degrading blocking scheme that includes:
determining whether the at least one client is Dynamic Host Control Protocol (DHCP) enabled, and, if the at least one client is not DHCP enabled,
informing a policy server through a policy key that a Layer 2 blocking can not be performed at the at least one client, and, in response, at the policy server,
blocking the at least one client at Layer 3.

44. The method of claim 39, further comprising:
determining whether the client has privelages to alter the ARP table, the route table, and the DNS, and if privileges are not available,
informing a policy server through a policy key that a Layer 2 blocking can not be performed at the at least one client, and, in response, at the policy server,
blocking the at least one client at Layer 3.

45. A system for network administration control, comprising:
a policy key on at least one client, for
scanning the at least one client for at least one configuration;
assessing at least one policy compliance based on the configuration; and
reporting a policy profile that identifies a policy state of the at least one policy compliance to a policy server, and
a policy server, for
receiving the policy profile from the policy key regarding the policy state of the at least one policy compliance of the at least one client;
evaluating at least one policy applying to the at least one client;
determining whether network access should be granted to the at least one client based on the policy state in view of the at least one policy; and
configuring network access to at least one endpoint solution of the at least one client if at least one policy state is not compliant.

46. The system of claim 45, further comprising:
an Address Resolution Protocol (ARP), wherein the policy key poisons the ARP table for routing back all communication attempts to the at least one client for preventing the client from communicating to other nodes on a subnet of the client

47. The system of claim 45, further comprising:
a route table, wherein the policy key removes a default gateway and at least one route from the route table for providing no path out of the client to a network available to the client for preventing a client from communicating to other nodes outside the subnet

48. The system of claim 47, wherein the policy key
opens communication to a remediation service by providing a route in the route table that corresponds to a predetermined remediation server.

49. The system of claim 45, wherein the policy key
redirects Domain Name Server (DNS) requests to the remediation server such that the at least one client is redirected to the remediation server.

50. The method of claim 39, wherein the policy key:
removes an IP addresses of a dynamic type having an associated Media Access Control (MAC), and
inserts the IP addresses with a static type and a MAC address of the client.

51. The system of claim 45, further comprising:
a Layer 3 device connected to the server for reporting an activity of an IP address corresponding to the at least one client, wherein the Layer 3 device is at least one of a router, switch, hub, or port-switch.

52. The system of claim 45, further comprising:
at least one remediation server connected to the server for providing remediation services to the at least one client.

53. The system of claim 46, further comprising:
a meter for cycling multiple clients in and out of the access table to schedule the configuring of the network access.
